(19) United States
(12) Patent Application Publication
(10) Pub. No.: US 2004/0124243 A1
(43) Pub. Date: Jul. 1, 2004

(54) Email ticket content

(76) Inventors: Jean-Marie Gatto, London (GB); Thierry Brunet De Courssou, Palo Alto, CA (US); Roman Woloszczuk, London (GB)

Correspondence Address: YOUNG LAW FIRM, A PROFESSIONAL CORPORATION, 4370 ALPINE ROAD SUITE 106, PORTOLA VALLEY, CA, 94028

(21) Appl. No.: 10/333,945

(22) PCT Filed: Aug. 3, 2001
(86) PCT No.: PCT/US01/24416

(51) Int. Cl. G06K 19/00

(52) U.S. Cl. 235/487

(57) ABSTRACT

Email content, email lottery ticket and methods that emulate a scratch ticket effect using DHTML programming code. As DHTML execution code is permitted in HTML enabled email software without fearing the introduction of malicious virus code, the method can advantageously be applied for sending emails containing scratch tickets enabling email recipients to win prizes. The method proposed emulates efficiently the necessary interactive image manipulation in DHTML code to provide a scratch ticket effect. The resulting email message is extremely compact in size and is well suited for mass emailing of very large quantities of scratch tickets. Additionally, the ticket may have multiple layers such as virtual latex layer (200) and secret layers (100). A selected number of such secret layers may reveal symbol sets (102) that correspond to prizes that may be claimed by the email recipient.

### CROSS-REFERENCE TO RELATED CASES

This invention is related in subject matter to commonly assigned and co-pending PCT application PCT/US01/______, which claims priority of U.S. provisional application serial No. 60/219,511 filed on Jul. 20, 2000. The present application claims priority of commonly assigned U.S. provisional application serial No. 60/224,072 filed on Aug. 9, 2000.

### BACKGROUND OF THE INVENTION

1. Field of the Invention

The invention pertains to the field of electronic gaming. More particularly, the present invention relates to electronic lottery tickets that may be delivered to recipients by email.

2. Description of the Related Art

Traditional lottery organizations earn significant revenues from the selling of email tickets, in which a specially formulated latex layer hides a set of secret symbols printed on a small piece of cardboard. The player then scratches the latex layer to reveal the hidden symbols. Predetermined sets of symbols correspond to winning prizes. Extreme security is applied in the formulation of paper, ink and latex, in the preparation process, in the distribution process and in the prize claiming process to avoid fraud.

The recent popularization of the Internet has given rise to a widespread proliferation of electronic games played on PCs (personal computers) via a standard World Wide Web (hereafter “Web”) browser and Internet connection. There are now numerous sites on the Web offering casino and lottery games. Not surprisingly, Internet gaming has met with significant success. Free gaming on the Web has proved to be especially popular, such that offered at www.FreeLotto.com. At FreeLotto.com, players need not pay or wager to enter a drawing or play, but are instead exposed to advertising in return for entering the drawing, playing the game or winning prizes. Web browser based email tickets may be played on Web sites such as www.prizes.com and www.realtimemedia.com. Depending on the game provider's business model, the pool of money from which prizes are paid is supplied either by direct payments from players and/or from advertisers, promoters or sponsors.

With attractive static or polished animated graphics, email ticket games can help build a strong connection between a target audience and promotion objectives. Scratch-off tickets, both on the Web and on paper, actively involve the players and offer instant gratification. Excitement builds as players expose hidden images and reveal winnings. On the Web, hyperlinks may be used to automatically draw a potential player to a promotional Web page. This process multiplies the effect of a promotion and can help achieve the stated objectives thereof better and faster than any other type of promotion.

Web browser-based gaming requires players to take the initiative to establish a connection with the web site that offers the game. Very quickly, however, the novelty of such gaming Web sites wears thin. Typically, as the initial excitement passes, the number of repeat visits to such sites decreases significantly.

### SUMMARY OF THE INVENTION

The present invention, according to an embodiment thereof, is an electronic email lottery ticket, comprising a first layer; a plurality of second layers stacked on top of the first layer, each of the plurality of second layers being initially transparent to show the first layer therethrough, a region of each of the plurality of second layers being configured to become opaque to reveal an image collectively formed by the opaque region of each of the plurality of second layers.

The region of each of the plurality of second layers may be configured to become opaque following a predetermined action by a recipient of the email ticket, such as moving and/or activating a pointer over the region. The first layer may be opaque. The first layer may include a bitmap. The bitmap may be configured to resemble a latex layer of a cardboard scratch lottery ticket, for example. The bitmap may be configured to include a promotional message. The second layer may include a bitmap. The bitmap may include an image of a combination of symbols. One or more of the plurality of second layers may include authentication information. A DHTML CLIP attribute (for example) may be used to selectively render each of the plurality of second layers transparent and to selectively render the region of each of the plurality of second layers opaque. The region of each of the plurality of second layers may be rectangular in shape. The region of each of the plurality of second layers may occupy an area that does not overlap with other regions of other ones of the plurality of second layers when the plurality of second layers are stacked on top of the first layer.

According to another embodiment thereof, the present invention is an electronic email lottery ticket, comprising a first layer, the first layer including an image; and a plurality of second layers stacked on top of the first layer, each of the plurality of second layers including an initially opaque region that masks a corresponding underlying portion of the image, each of the plurality of second layers being configured to become transparent to reveal the corresponding underlying portion of the image.

The opaque region of each of the plurality of second layers may be configured to become transparent following a predetermined action by a recipient of the email ticket. The predetermined action may include moving and/or activating a pointer over the region. The first layer may be opaque. The image may include a bitmap. The bitmap may show a combination of symbols. At least the first layer may include authentication information. A DHTML CLIP attribute (for example) may be used to selectively render the region of each of the second layers opaque and to selectively render each of the plurality of second layers transparent. The opaque region of each of the plurality of second layers may be rectangular in shape. The opaque region of each of the plurality of second layers may occupy an area that does not overlap with other opaque regions of other ones of the plurality of second layers when the plurality of second layers are stacked on top of the first layer.

The present invention is also a method of making content for an electronic email lottery ticket, comprising the steps of providing a first layer; and providing a plurality of second layers and staking the plurality of second layers on top of the first layer, each of the plurality of second layers being initially transparent to show the first layer therethrough, a region of each of the plurality of second layers being configured to become opaque to reveal an image collectively formed by the opaque region of each of the plurality of second layers.

The region of each of the plurality of second layers may be configured to become opaque following a predetermined action by a recipient of the email ticket. The predetermined action may include moving and/or activating a pointer over the region, for example. The first layer may be opaque and may include a bitmap. The bitmap may be configured to resemble a latex layer of a cardboard scratch lottery ticket, for example, or may be configured to include a promotional message. The second layer may include a bitmap of an image of a combination of symbols. One or more of the plurality of second layers may include authentication information. A DHTML CLIP attribute may be used to selectively render each of the plurality of second layers transparent and to selectively render the region of each of the plurality of second layers opaque. The region of each of the plurality of second layers may be rectangular in shape. The region of each of the plurality of second layers may occupy an area that does not overlap with other regions of other ones of the plurality of second layers when the plurality of second layers are stacked on top of the first layer.

The present invention is also a method of making content for an electronic email lottery ticket, comprising the steps of providing a first layer, the first layer including an image; providing a plurality of second layers and stacking the plurality of second layers on top of the first layer, each of the plurality of second layers including an opaque region that initially masks a corresponding underlying portion of the image, each of the plurality of second layers being configured to become transparent to reveal the corresponding underlying portion of the image.

The opaque region of each of the plurality of second layers may be configured to become transparent following a predetermined action by a recipient of the email ticket, such as moving and/or activating a pointer over the region, for example. The first layer may be opaque and may include a bitmap. The bitmap may show a combination of symbols. At least the first layer may include authentication information. A DHTML CLIP attribute may be used to selectively render the region of each of the second layers opaque and to selectively render each of the plurality of second layers transparent. The opaque region of each of the plurality of second layers may be rectangular in shape. The opaque region of each of the plurality of second layers may occupy an area that does not overlap with other opaque regions of other ones of the plurality of second layers when the plurality of second layers are stacked on top of the first layer.

### BRIEF DESCRIPTION OF THE DRAWINGS

FIG. 1 is a representation of a secret layer of an email ticket, according to an embodiment of the present invention.

FIG. 2 is a representation of a virtual latex layer of an email ticket, according to an embodiment of the present invention.

FIG. 3 is an illustration of secret layer stacking on top of a virtual latex layer, according to an embodiment of the present invention.

FIG. 4 shows the clipping region defined by a rectangle, according to an embodiment of the present invention.

FIG. 5 shows a grid and coordinate system for 9 clipping regions, according to an embodiment of the present invention.

FIG. 6 illustrates methods for dynamic clipping of secret layers or virtual latex layers for an illustrative 300×300 pixel bitmap, according to embodiments of the present invention.

FIG. 7 shows a secret layer in which the center clipping region has been revealed, according to an embodiment of the present invention.

FIG. 8 is a flowchart of a first method for the creation and initialization of content for an email ticket that includes 9 instances of a secret layer, according to an embodiment of the present invention.

FIG. 9 is a flowchart illustrating a first method for the revealing the underlying and initially hidden symbols of an email ticket according to an embodiment of the present invention.

FIG. 10 is an illustration of the stacking of a plurality of virtual latex layers on top of a secret layer, according to another embodiment of the present invention.

FIG. 11 illustrates a second method for dynamic clipping of virtual latex layers for an illustrative 300×300 pixel bitmap, according to another embodiment of the present invention.

FIG. 12 is a flowchart of a second method for the creation and initialization of content for an email ticket that includes 9 instances of a virtual latex layer, according to another embodiment of the present invention.

FIG. 13 is a flowchart illustrating a second method for the revealing the underlying and initially hidden symbols of an email ticket according to an embodiment of the present invention.

FIG. 14 shows a secret layer in which the center region has been revealed, according to another embodiment of the present invention.

FIG. 15 shows a grid and coordinate systems for 25, 81 and 144 clipping regions, according to further embodiments of the present invention.

FIG. 16 shows a grid and coordinate system that produces rectangular clipping regions, according to still further embodiment of the present invention.

### DETAILED DESCRIPTION OF THE INVENTION

The present invention offers another dimension in the Internet gaming whereby players can receive an electronic counterpart of traditional scratch paper tickets via email and win prizes without having to make the effort of connecting to a Web site to play. According to the present invention, an email ticket includes one or more virtual latex layers and one or more secret layers. The virtual latex layer is that which is seen by the player on his or her screen before a set of secret symbols is gradually revealed. The secret layers may advantageously be smaller than the virtual latex layer(s) and may be selectively revealed at some place under the virtual latex layer(s). According to the present invention, the virtual latex layer(s) and the secret layer(s) are combined in an email ticket such that the virtual latex layer(s) is shown first, and then the secret symbols on the secret layer(s) are revealed after some interaction with the email recipient (the player).

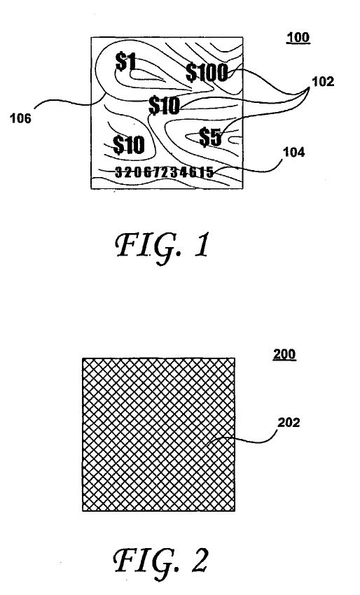

Two illustrative embodiments of the present invention are described herein and in the accompanying figures. FIG. 1 is a representation of a secret layer 100 of an email ticket, according to an embodiment of the present invention. As shown, the secret layer 100 includes a plurality of symbols 102 that collectively constitute a symbol set. The secret layer 100 and the symbols 102 may be rendered as a bitmapped matrix of pixels, for example. Various symbols 102 are possible as are various combinations thereof. Indeed, it is understood that the symbols shown herein are illustrative only and are not intended to limit the present invention. A selected number of such secret layers may reveal symbol sets that correspond to a prize that may be claimed by the email recipient. The symbols 102 may be rendered against a random unobtrusive background 106. Such a random unobtrusive background may be composed of small dots, small stars, small symbols, fine waving lines as found on banknotes or any other non obtrusive patterns. Authentication information 104 may be included in the secret layer 100, to enable the authentication of the validity of a potentially winning email ticket presented for payment by a prize claimant. Such authentication information 104 may include, for example, a Transaction Serial Number (TSN), which is a serial number denoting the order in which the email ticket was created and/or sent to its intended recipient. Such information may be suitably scrambled and/or encrypted to prevent fraud. Aspects of the email ticket creation, distribution and validation procedures detailed in the above-referenced PCT/US01/______ application may be advantageously used herein.

FIG. 2 is a representation of a virtual latex layer 200 of an email ticket, according to an embodiment of the present invention. The virtual latex layer 200 is preferably opaque and may resemble the latex layer on a conventional cardboard scratch ticket or may incorporate or reference code that is configured to deliver rich content such as images, video, sound effects and/or music. The design of the virtual latex layer 200 may include, for example, a promotional message, as disclosed in the aforementioned application PCT/US01/______. The following, however, assumes that the virtual latex layer 200 is an opaque layer of a single color, as indicated by reference numeral 202. The opaque virtual latex layer(s) 200 is shaped and dimensioned to mask the secret layer(s) 100 when the secret layer(s) 100 and the virtual latex layer(s) 200 are stacked on top of one another. For example, the virtual latex layer(s) 200 may be the same size and shape as the secret layer(s) 100 or the same or different shape and larger than the secret layer(s) 100.

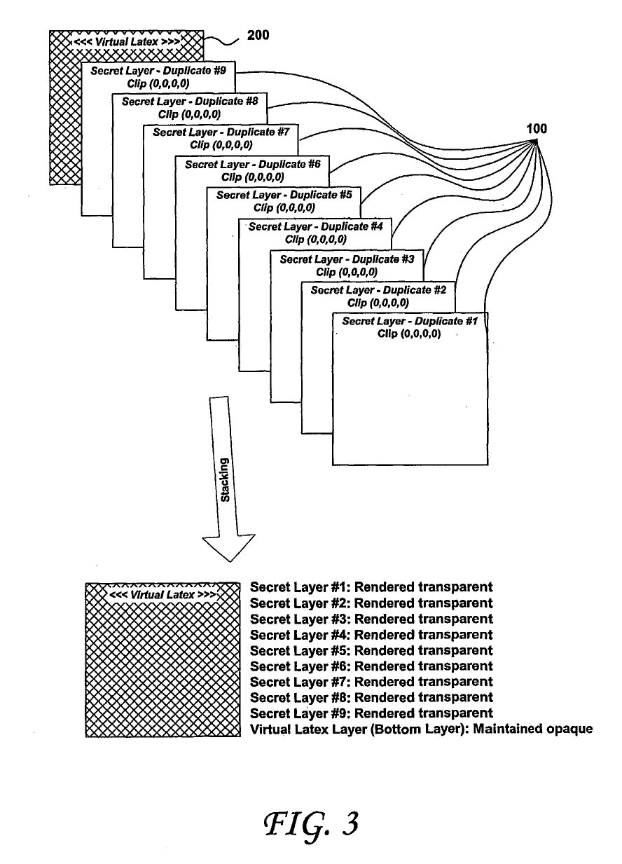

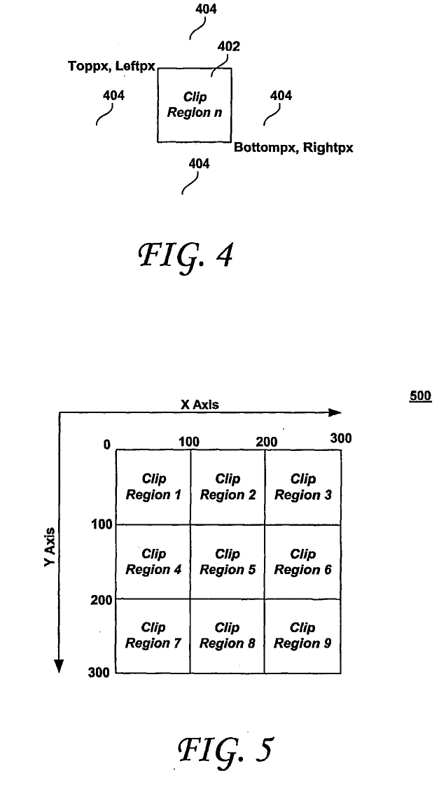

FIG. 3 is an illustration of the structure of the content of an email ticket according to the present invention, showing an illustrative embodiment thereof in which a plurality of secret layers 100 are stacked on top of the virtual latex layer 200, according to a first embodiment of the present invention. According to the present invention, content suitable for inclusion in an email ticket includes a virtual latex layer 200, and a plurality of stacked secret layers 100. Each of the secret layers 100 may be identical, and may be initially rendered transparent such that, when stacked, only the virtual latex layer 200 is visible, as shown in the bottom portion of FIG. 3. As shown in FIG. 3, each of the secret layers may include the same secret symbol set and optionally the unobtrusive random pattern 106, although the secret symbol set and the pattern 106 are not visible in FIG. 3, as each of the secret layers 100 have been rendered transparent (although the secret layers 100 in FIG. 3 are shown with white fill for ease of illustration only). According to one embodiment of the present invention, the secret layers 100 may be rendered transparent using the DHTML CLIP attribute to set a clipping region (usually rectangular) of size zero. DHTML is described, for example, in Dynamic HTML, The Definitive Reference, Danny Goodman, O'Reilly & Associates, Inc. ©(1998, which is incorporated herein in its entirety. As noted in this reference, a clipping region is a geometric area though which positioned content is visible. As the CLIP attribute causes any area that is beyond the clipping region to become transparent, specifying a clipping region of zero size for each of the secret layers 100 causes the entire area of each secret layer 100 to become transparent, as shown in FIG. 3. According to one implementation thereof, the CLIP attribute includes a shape and four numeric values delimiting the top, right, bottom and left of the clipping region and has the following format: clip:rect(toppx rightpx bottompx leftpx), where “px” denotes pixel. A clipping region is shown in FIG. 4. The area 402 inside the clipping region bounded by the toppx, rightpx, bottompx and leftpx delimiters is visible and the entire area 404 of the layer outside the clipping region is transparent. Returning now to FIG. 3, by specifying the top, right, bottom and left pixel delimiters of the CLIP attribute as being zero, no area of the secret layer 100 is visible and the entire secret layer 100 is rendered transparent. By stacking a plurality of such secret layers 100 and specifying a clipping region of zero, the entire stack of the plurality of secret layers 100 is made transparent, thereby rendering visible only the underlying virtual latex layer 200, for which no CLIP attribute is set (or for which the clipping region specifies the entire surface area thereof). An email ticket, according to the present invention, may include such a stacked virtual latex layer 200 and secret layers 100 construct, configured such that the plurality of secret layers 100 are initially transparent and only the underlying virtual latex layer 200 is visible therethrough.

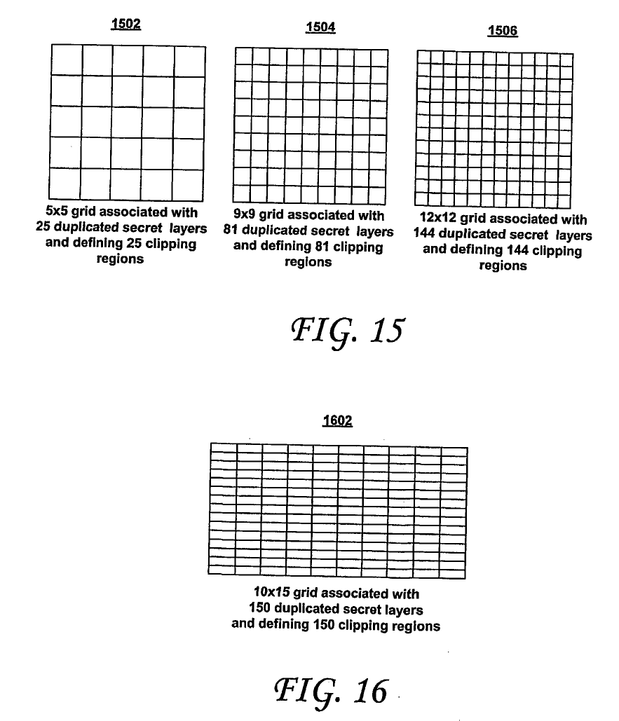

FIG. 5 shows a grid and coordinate system 500 for 9 clipping regions, according to an embodiment of the present invention. The grid and coordinate system 500 divides each of the plurality of secret layers 100 into nine distinct clipping regions. As shown, each clipping region is a square 100 pixels on a side, although other dimensions may be chosen. Therefore, for a secret layer 100 that is dimensioned as a square 300 pixels on a side, 9 such square clipping regions of 100 pixels on a side may be defined. As shown in FIGS. 15 and 16, other grid and coordinate systems may be defined. For example, as shown in FIG. 15, reference numeral 1502 shows a 5×5 grid defining 25 clipping regions. Each clipping region, according to the present invention, is associated with one of the plurality of secret layers 100 or with one of the plurality of virtual latex layers 200. In the same manner that each of the 9 clipping regions the 3×3 grid 500 of FIG. 5 is associated with one of the 9 stacked duplicate secret layers 100 of FIG. 3, each of the 25 clipping regions of the grid 1502 may be associated with one of 25 duplicate secret layers 100, each stacked on top of a single virtual latex layer 200. Alternatively, each of the 25 clipping regions of the grid 1502 may be associated with one of the 25 duplicate virtual latex layers, each stacked on top of a single secret layer 100. Similarly, each of the 81 clipping regions the 9×9 grid 1504 may be associated with one of 81 duplicate secret layers 100, each stacked on top of a single virtual latex layer 200 in the manner shown in FIG. 3 or may be associated with one of 81 duplicate virtual latex layers 200, each stacked on top of a single secret layer 100. Likewise, each of the 144 clipping regions the 12×12 grid 1506 may be associated with one of 144 duplicate secret layers 100, each stacked on top of a single virtual latex layer 200. Alternatively, each of the 144 clipping regions may be associated with one of 144 duplicate virtual latex layers 200, each stacked on top of a single secret layer 100. The clipping regions need not be square, as shown at FIG. 16. Indeed, each of the 150 clipping regions the 10×15 grid 1602 may be associated with one of 150 duplicate secret layers 100, each stacked on top of a single virtual latex layer 200, as shown in FIG. 16, or may be associated with one of 150 virtual latex layers 200, each stacked on top of a single secret layer 100. According to the present invention, the clipping regions need not be rectangular, but may have any predetermined shape. However, current implementations of the DHTML CLIP attribute allow only rectangular clipping regions. The present invention, however, is not so limited.

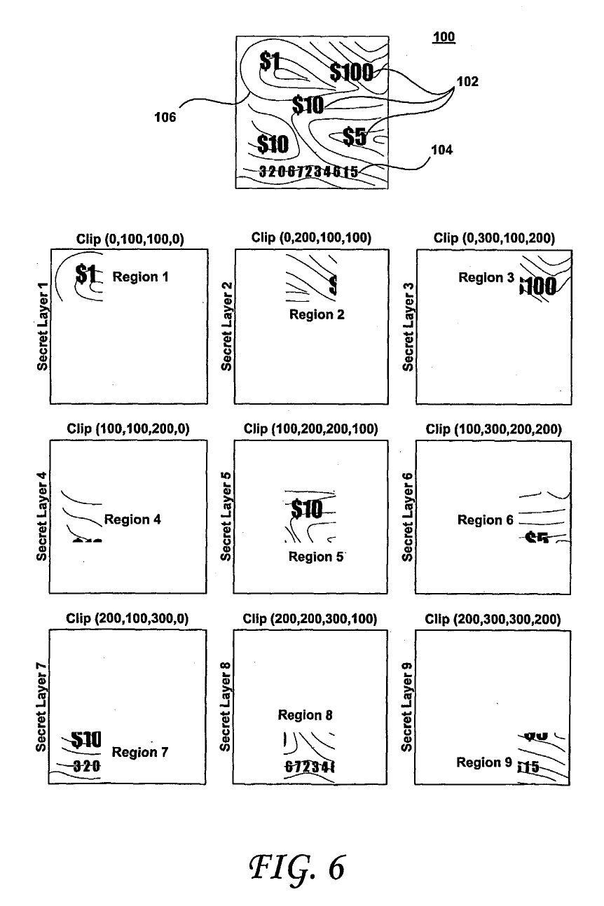

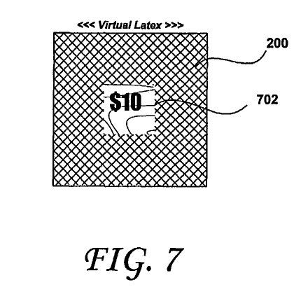

FIG. 6 illustrates aspects of a first method for dynamic clipping of layers for an illustrative 300×300 pixel bitmap, according to an embodiment of the present invention. The illustrative secret layer 100 of FIG. 1 is reproduced in FIG. 6 for reference purposes. FIG. 6 shows the manner in which a selected region of each of the 9 stacked and initially transparent secret layers 100 of FIG. 3 may be rendered opaque (i.e., visible), according to an embodiment of the present invention. The secret layer 1 may be the top-most secret layer and the secret layer 9 may the bottom-most secret layer, directly overlying the virtual latex layer 200 (see FIG. 3). As shown, following a predetermined action by the email ticket recipient, the clipping region 1 may be rendered visible. According to one embodiment of the present invention, the clipping regions may be selectively rendered visible to the email ticket recipient using the DHTM CLIP attribute. For example, to render the portion of the bitmapped secret layer defined as clipping region 1 visible, a DHTML CLIP attribute may be set, formatted as follows: clip:rect(0 100 100 0). According to an embodiment of the present invention, the predetermined action by the email recipient that selectively renders the clipping regions visible may include, for example, moving a cursor on the screen of the personal computer, computing or mobile device having received the email ticket over an area of the stacked secret layers 100 corresponding to a clipping region. Indeed, the present email ticket is configured such that when the cursor is dragged over an area of the stacked secret layers 100 corresponding to clipping region 1, the four numeric clipping region delimiters of the DHTML CLIP instruction are reset from (0 0 0 0) to (0 100 100 0), which renders the clipping region 1 visible, while maintaining the remaining portion of the secret layer 1 (and of the other secret layers 2-9 in the case wherein 9 secret layers are stacked on top of a virtual latex layer 200) transparent. Likewise, should the email recipient move his or her cursor over an area of the stacked secret layers 100 corresponding to the clipping region 5, the clipping region 5 (identified in FIG. 7 by reference 702) will appear as shown in FIG. 7, as the four numeric clipping region attributes specify that a rectangle bounded by the top pixel 100, the right pixel 200, the bottom pixel 200 and the left pixel 100 is to be rendered visible, while maintaining all other regions of secret layer 5 transparent. By moving the cursor or other pointer by means of a pointing device, the email recipient may gradually render all of the clipping regions 1-9 visible and reveal the entire symbol set of secret symbols 102 on the underlying bitmapped secret layers 100. Therefore, as the email recipient moves his or her cursor over the surface of the stacked and duplicated secret layers 100, the symbols 102 are gradually revealed and the virtual latex layer 200 is correspondingly and gradually masked by the clipping regions, until the complete secret layer 100 is re-constituted and the entire virtual latex layer 200 is completely masked by a mosaic of 9 clipping regions that together reveal the entire set of symbols 102 shown in the representative secret layer 100. If the revealed symbol set is a winning combination of symbols 102, the email recipient may claim a prize that corresponds to the revealed combination of symbols 102. Any means of selectively rendering the clipping regions visible may be implemented within the context of the present invention. Indeed, the present inventions are not to be limited to the embodiment detailed above using the DHTML CLIP attribute.

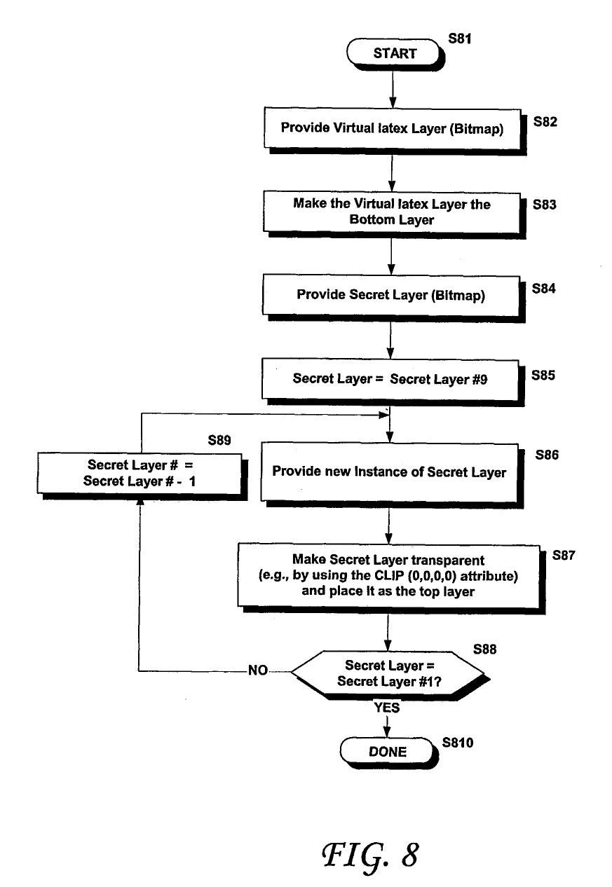

FIG. 8 is a flowchart of a first method for the creation and initialization of content for an email ticket that includes 9 instances of a secret layer, according to an embodiment of the present invention. The method starts at S81, wherein a virtual latex layer 200 is provided, as shown at S81. The virtual latex layer 200, for example, may be or include a bitmap that, when rendered on a screen, displays a surface resembling a latex layer of a cardboard scratch ticket or displays some promotional message, advertising, etc. The virtual latex layer 200, as shown at S83, is made to be the bottom layer. Step S84 calls for the provision of a secret layer 100. The secret layer 100, for example, may be or include a bitmap that, when rendered on a screen, displays a set of secret symbols, such as those shown at 102 in FIG. 1. The secret layer provided in step S84 may then be assigned a secret layer number. In the illustrated case of a 3×3 grid and 9 stacked duplicate secret layers, the secret layer provided in step S84 is assigned as the secret layer number 9. A new instance of the secret layer is then provided, as shown at S86. For example, the secret layer provided in step S84 may be duplicated. The new instance of the secret layer is then initialized and made transparent. According to an embodiment of the present invention, the secret layers are made initially transparent by using the DHTML CLIP attribute and setting the numeric clipping region delimiters to (0 0 0 0), as shown at S87, although other means may be employed. The number of the secret layer is then tested to determine if it is equal to 9 (for a 3×3 grid of clipping regions and 9 stacked duplicated secret layers). If not, the secret layer number is decremented, as shown at S89 and steps S86, S87 and S88 are repeated until the test at S88 is true; that is, until the last instance of the secret layer has been provided and rendered transparent. The method ends at S810.

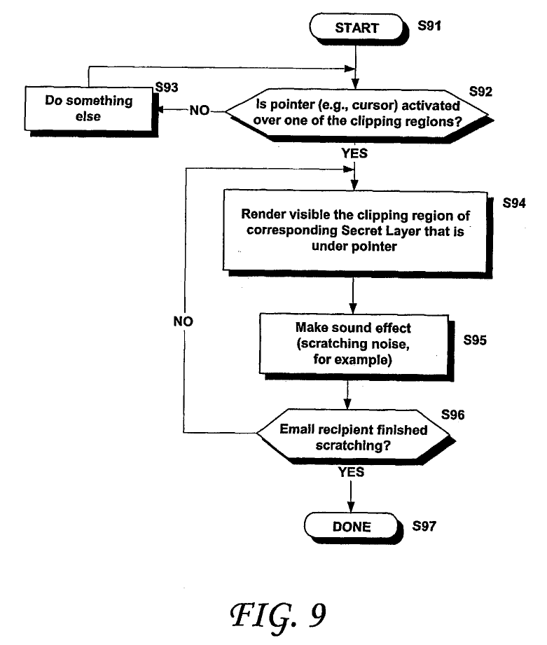

FIG. 9 is a flowchart illustrating a first method for the revealing the underlying and initially hidden symbols of an email ticket according to an embodiment of the present invention. The method starts at S91. At Step S92, it is determined whether the pointer (such as a cursor controlled by a pointing device such as a mouse or a trackball, for example) is currently located over (and/or is activated, such as a click of a mouse button, for example) one of the clipping regions of one of the stacked and duplicated secret layers, such as shown in FIG. 3. If the cursor or other pointer is not currently positioned and/or activated over one of the clipping regions of the stack of secret layers 100, another step S93 may be carried out and the method may then revert back to step S92. Step S93 may include doing nothing, making a sound, playing music and/or sound effects or any other activity. At S94, if the cursor is indeed currently over (and/or activated) over the clipping region of one of the stacked secret layers 100 (such as shown in FIG. 6), that clipping region may be changed from transparent to opaque (i.e., rendered visible to the email recipient or player). This may be done, for example, by appropriately setting the numerical clipping region delimiters of the DHTML CLIP instructions, as detailed above. A sound effect such as a scratching noise, for example) may accompany or follow step S94. If all clipping regions have been rendered visible or the email recipient or player has finished scratching (selectively revealing the initially hidden clipping regions to render the clipping regions of the secret layer 100 visible), the method ends at S97. Otherwise, the method may revert back to step S94 until the email recipient or player has finished scratching or until all clipping regions have been revealed. If the revealed symbols 102 correspond to a winning combination, the email recipient or player may claim the prize associated with the combination.

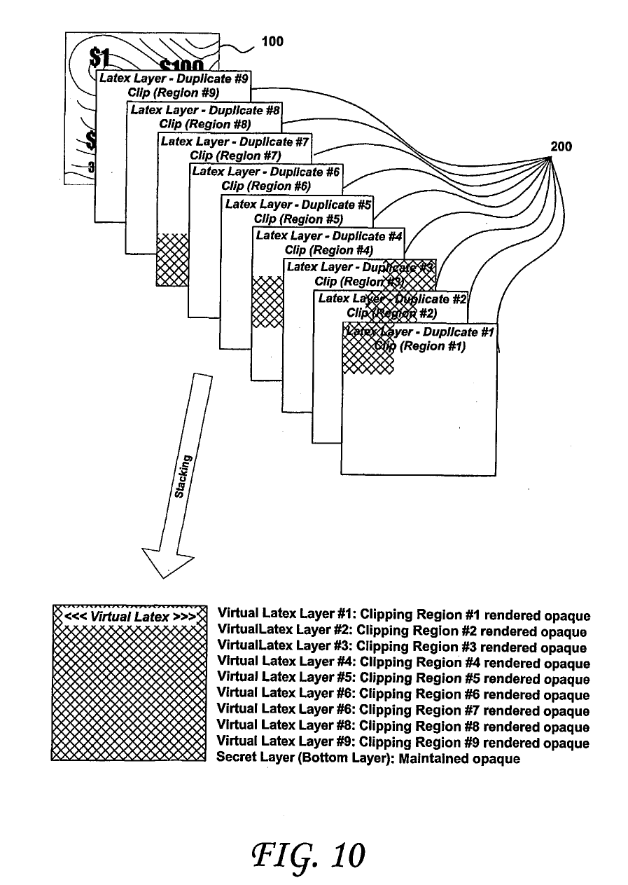

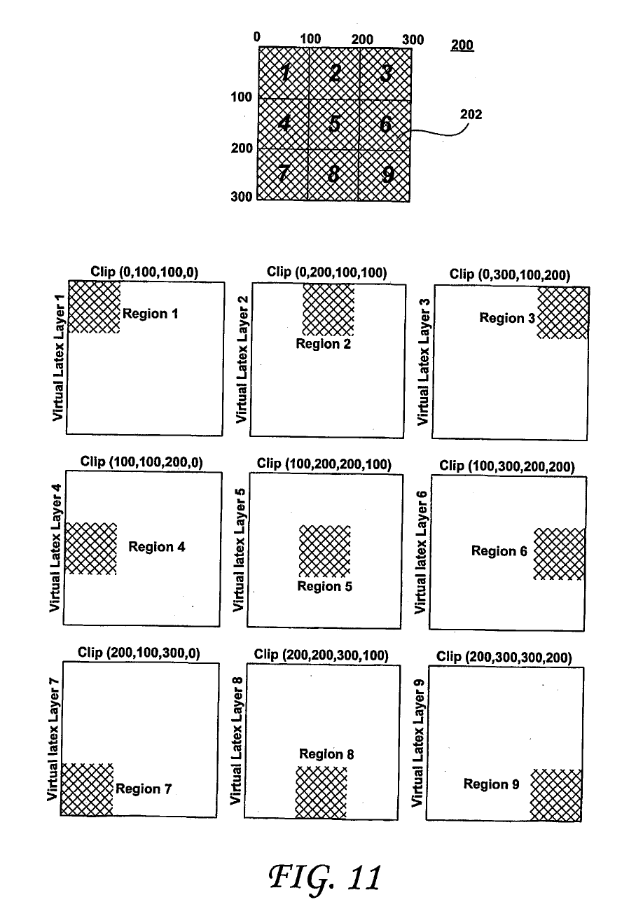

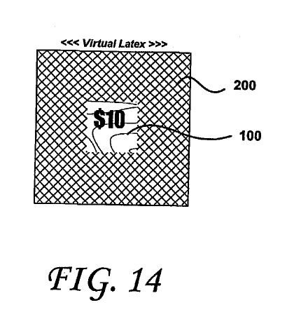

FIG. 10 is an illustration of the stacking of a plurality of duplicate virtual latex layers 200 on top of a single secret layer 100, according to another embodiment of the present invention. As shown therein, instead of stacking a plurality of initially transparent secret layers 100 on top of a single virtual latex layer 200, the embodiment of the present invention shown in FIG. 10 contemplates stacking a plurality of numbered duplicate virtual latex layers 200 on top of a single secret layer 100. Separate clipping regions of each of the plurality of stacked and numbered virtual latex layers 200 may be rendered initially opaque using the DHTML CLIP attribute, wherein the numeric clipping region delimiters are all set to render visible only a selected clipping region corresponding to the number of the virtual latex layer. FIG. 11 illustrates a second method for dynamic clipping of virtual latex layers 200 for an illustrative 300×300 pixel bitmap, according to another embodiment of the present invention. The virtual latex layer 200 is also shown in FIG. 11, overlaid with a grid and coordinate system for ease of reference. The numbers within the virtual latex layer correspond to the numbers of the clipping regions. As shown therein, a selected region of each of the numbered and stacked virtual latex layers 200 is initially opaque, the selected regions together forming a stacked mosaic of such regions that, when viewed together, reconstitute the virtual latex layer 200. The DHTML CLIP attribute may again be used here, to render the 9 clipping regions of the virtual latex layers 200 of the stacked plurality of such layers opaque (i.e., visible). For example, as again shown in FIG. 14, a clip attribute may be reset from clip:rect(100, 200 200 100)—which renders clipping region 5 of the virtual latex layer 5 visible to clip:rect(0 0 0 0), thereby rendering the entire virtual latex layer 5 transparent to reveal the underlying corresponding portion of the secret layer 100. According to this embodiment of the present invention, when a pointer is moved (and/or activated) over a clipping region, that clipping region is rendered transparent, to enable the corresponding portion of the underlying secret layer 100 to become visible. This may be done, according to the present invention, by resetting the numerical clipping region delimiters to zero. That is, the respective initially opaque clipping regions 1-9 of the example of FIGS. 10 and 11 may be rendered transparent by selectively changing the numerical clipping region delimiters to zero. When all clipping regions (and/or the entire area) of the virtual latex layers have been rendered transparent, the entire underlying secret layer 100 is revealed, to reveal the combination of secret symbols 102.

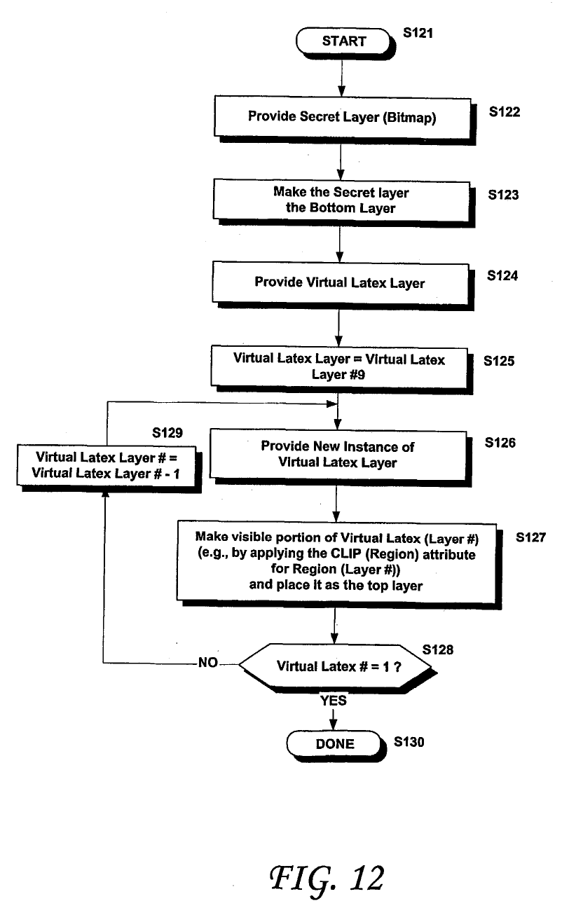

FIG. 12 is a flowchart of a second method for the creation and initialization of content for an email ticket that includes 9 instances of a virtual latex layer 200, according to another embodiment of the present invention. The method begins at S121. At S122, a secret layer 100 is provided, as shown at FIG. 10. The secret layer 100 is made the bottom layer, as shown at S123. Step S124 calls for the provision of a virtual latex layer 200, which is then assigned the number 9 in this illustrative embodiment of a 3×3 grid and an email ticket containing 9 stacked virtual latex layers 200, as shown at S125. For a 10×10 grid, the first provided latex layer 200 would be assigned the number 100, and so on. A new instance (a duplicate) of the provided virtual latex layer 200 is then provided at step S126. A region of the provided virtual latex layer 200 corresponding to the number of the virtual latex layer 200 is then rendered opaque (visible) using, for example, the clip attribute. For example and as shown at FIG. 11, region 9 of the virtual layer number 9 is rendered visible by setting the numerical clipping region delimiters so as to render only clipping region 9 visible; i.e., by setting the clip attribute as follows: clip:rect(200 300 300 200). The number of the virtual latex layer 200 is then tested in step S128 to determine if the last virtual latex layer (virtual latex layer number 1) has been provided and processed, as set forth in steps S126 and S127. If not, the number of the virtual latex layer 200 is decremented in step S129 and the method reverts to step S126 until the number of the virtual latex layer is equal to 1, whereupon the method ends at S130.

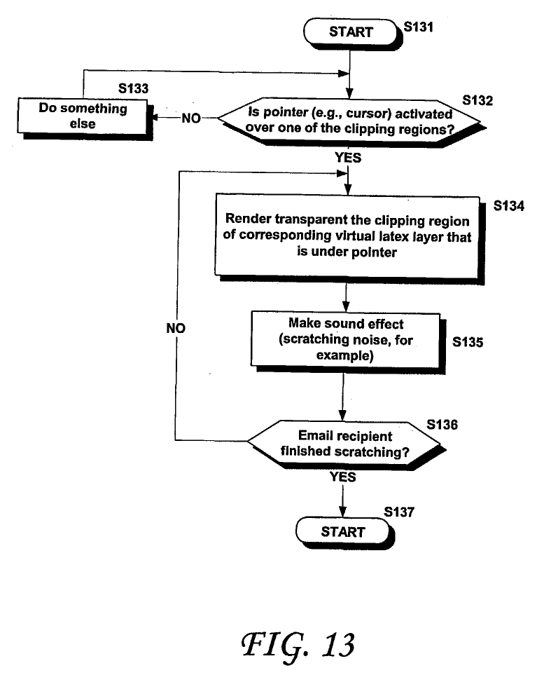

FIG. 13 is a flowchart illustrating a second method for the revealing the underlying and initially hidden symbols of an email ticket according to an embodiment of the present invention. The method begins at S131, whereupon it is determined whether the cursor is currently over (and/or activated) over the opaque clipping region of one of the plurality of stacked virtual latex layers 200. If the pointer is not over one of the clipping region of one of the virtual latex layers 200, step S133 may be carried out, similarly to step S93 in FIG. 9. If the cursor is currently positioned (and/or activated) over one of the clipping regions shown in FIG. 11, step S134 is carried out, whereupon the underlying clipping region is rendered transparent to reveal the corresponding portion of the underlying secret layer 100. This may be carried out by resetting the numerical clipping region delimiters to (0 0 0 0) and rendering the corresponding virtual latex layer transparent. Concurrently with or after step S134, a sound effect (such as a scratching noise, for example) may be generated, to further heighten the player's gaming experience. If the email recipient or player has finished revealing the underlying secret layer 100 as shown at S136 or if the entire secret layer 100 is revealed, the method ends at S137. Otherwise, the method may revert to step S134 to repeat steps S134, S135 and S136 until step S137 is ultimately reached. Should the revealed combination of symbols 102 match a predetermined winning combination of such symbols 102, the email recipient or player may claim a prize.

To prevent virus intrusion via email, embedded or attached execution code such as Java or ActiveX is preferably not utilized. HTML enabled email software such as Microsoft Outlook and Outlook Express (for example) permits the execution of embedded DHTML code. The DHTML execution code configured to carry out the present invention and to generate the present content for email tickets is embedded in the HTML information of the email message and thus does not appear as an email attachment. As the email recipient is not sent an attachment, he or she is not reticent of opening the received email message, for fear of an email-type virus being embedded in an attachment.

Alternatively to the Clip attribute, the opacity( ) instruction of the DHTML language may be applied to regions similar to the clipping regions described herein, whereby the opacity of a given virtual latex layer or secret layer bitmap image may be set from a value of 100% (visible) to 0% (transparent), but may be less efficient and less flexible than the clip attribute.

A clipping region, according to the present invention, is a rectangular view of the full SPAN content. Only content that is within the clipping rectangle can be seen on the page.

Example: <SPAN STYLE==“clip:rec(0px 50px 50px 0px)”><IMG SRC=“Mylmage.tif”></SPAN>

Content of the full layer outside the clipping region is transparent.

Other grid dimensions and thus other clipping region dimensions may readily be defined within the context of the present invention, as described relative to FIGS. 15 and 16. Appendix A includes printouts of two sample email tickets and relevant portions of the corresponding source code.

While the foregoing detailed description has described preferred embodiments of the present invention, it is to be understood that the above description is illustrative only and not limiting of the disclosed invention. Modifications may occur to those of skill in this art. Thus, the present invention to be limited only by the claims as set forth below.

[image]

[image]

[image]

[image]

[image]

[image]

[image]

1. An electronic email lottery ticket, comprising:
a first layer;
a plurality of second layers stacked on top of the first layer, each of the plurality of second layers being initially transparent to show the first layer therethrough, a region of each of the plurality of second layers being configured to become opaque to reveal an image collectively formed by the opaque region of each of the plurality of second layers.

2. The email ticket of claim 1, wherein the region of each of the plurality of second layers is configured to become opaque following a predetermined action by a recipient of the email ticket.

3. The email ticket of claim 2, wherein the predetermined action includes at least one of moving and activating a pointer over the region.

4. The email ticket of claim 1, wherein the first layer is opaque.

5. The email ticket of claim 1, wherein the first layer includes a bitmap.

6. The email ticket of claim 5, wherein the bitmap is configured to resemble a latex layer of a cardboard scratch lottery ticket.

7. The email ticket of claim 5, wherein the bitmap is configured to include a promotional message.

8. The email ticket of claim 1, wherein the second layer includes a bitmap.

9. The email ticket of claim 8, wherein the bitmap includes an image of a combination of symbols.

10. The email ticket of claim 1, wherein at least one of the plurality of second layers includes authentication information.

11. The email ticket of claim 1, wherein a DHTML CLIP attribute is used to selectively render each of the plurality of second layers transparent and to selectively render the region of each of the plurality of second layers opaque.

12. The email ticket of claim 1, wherein the region of each of the plurality of second layers is rectangular in shape.

13. The email ticket of claim 1, wherein the region of each of the plurality of second layers occupies an area that does not overlap with other regions of other ones of the plurality of second layers when the plurality of second layers are stacked on top of the first layer.

14. An electronic email lottery ticket, comprising:
a first layer, the first layer including an image;
a plurality of second layers stacked on top of the first layer, each of the plurality of second layers including an initially opaque region that masks a corresponding underlying portion of the image, each of the plurality of second layers being configured to become transparent to reveal the corresponding underlying portion of the image.

15. The email ticket of claim 14, wherein the opaque region of each of the plurality of second layers is configured to become transparent following a predetermined action by a recipient of the email ticket.

16. The email ticket of claim 15, wherein the predetermined action includes at least one of moving and activating a pointer over the region.

17. The email ticket of claim 14, wherein the first layer is opaque.

18. The email ticket of claim 14, wherein the image includes a bitmap.

19. The email ticket of claim 18, wherein the bitmap shows a combination of symbols.

20. The email ticket of claim 14, wherein at least the first layer includes authentication information.

21. The email ticket of claim 14, wherein a DHTML CLIP attribute is used to selectively render the region of each of the second layers opaque and to selectively render each of the plurality of second layers transparent.

22. The email ticket of claim 14, wherein the opaque region of each of the plurality of second layers is rectangular in shape.

23. The email ticket of claim 14, wherein the opaque region of each of the plurality of second layers occupies an area that does not overlap with other opaque regions of other ones of the plurality of second layers when the plurality of second layers are stacked on top of the first layer.

24. A method of making content for an electronic email lottery ticket, comprising the steps of:
providing a first layer;
providing a plurality of second layers and staking the plurality of second layers on top of the first layer, each of the plurality of second layers being initially transparent to show the first layer therethrough, a region of each of the plurality of second layers being configured to become opaque to reveal an image collectively formed by the opaque region of each of the plurality of second layers.

25. The method of claim 24, wherein the region of each of the plurality of second layers is configured to become opaque following a predetermined action by a recipient of the email ticket.

26. The method of claim 25, wherein the predetermined action includes at least one of moving and activating a pointer over the region.

27. The method of claim 24, wherein the first layer is opaque.

28. The method of claim 24, wherein the first layer includes a bitmap.

29. The method of claim 28, wherein the bitmap is configured to resemble a latex layer of a cardboard scratch lottery ticket.

30. The method of claim 28, wherein the bitmap is configured to include a promotional message.

31. The method of claim 24, wherein the second layer includes a bitmap.

32. The method of claim 31, wherein the bitmap includes an image of a combination of symbols.

33. The method of claim 24, wherein at least one of the plurality of second layers includes authentication information.

34. The method of claim 24, wherein a DHTML CLIP attribute is used to selectively render each of the plurality of second layers transparent and to selectively render the region of each of the plurality of second layers opaque.

35. The method of claim 24, wherein the region of each of the plurality of second layers is rectangular in shape.

36. The method of claim 24, wherein the region of each of the plurality of second layers occupies an area that does not overlap with other regions of other ones of the plurality of second layers when the plurality of second layers are stacked on top of the first layer.

37. A method of making content for an electronic email lottery ticket, comprising the steps of:
providing a first layer, the first layer including an image;
providing a plurality of second layers and stacking the plurality of second layers on top of the first layer, each of the plurality of second layers including an opaque region that initially masks a corresponding underlying portion of the image, each of the plurality of second layers being configured to become transparent to reveal the corresponding underlying portion of the image.

38. The method of claim 37, wherein the opaque region of each of the plurality of second layers is configured to become transparent following a predetermined action by a recipient of the email ticket.

39. The method of claim 38, wherein the predetermined action includes at least one of moving and activating a pointer over the region.

40. The method of claim 37, wherein the first layer is opaque.

41. The method of claim 37, wherein the image includes a bitmap.

42. The method of claim 41, wherein the bitmap shows a combination of symbols.

43. The method of claim 37, wherein at least the first layer includes authentication information.

44. The method of claim 37, wherein a DHTML CLIP attribute is used to selectively render the region of each of the second layers opaque and to selectively render each of the plurality of second layers transparent.

45. The method of claim 37, wherein the opaque region of each of the plurality of second layers is rectangular in shape.

46. The method of claim 37, wherein the opaque region of each of the plurality of second layers occupies an area that does not overlap with other opaque regions of other ones of the plurality of second layers when the plurality of second layers are stacked on top of the first layer.
